(19) United States
(12) Patent Application Publication
(10) Pub. No.: US 2007/0229215 A1
(43) Pub. Date: Oct. 4, 2007

(54) Modular Entertainment System

(75) Inventor: Hemant JHA, Los Angeles, CA (US)

Correspondence Address: FITCH EVEN TABIN & FLANNERY, 120 SOUTH LASALLE SUITE 1600, CHICAGO, IL, 60603, US

(73) Assignees: Sony Corporation, Tokyo (JP); Sony Electronics Inc., Park Ridge, NJ (US)

(21) Appl. No.: 11/554,886

(22) Filed: Oct. 31, 2006

Related U.S. Application Data
(60) Provisional application No. 60/781,604, filed on Mar. 10, 2006.

(51) Int. Cl. G05B 23/02

(52) U.S. Cl. 340/3.1; 340/825.25; 381/311; 340/825.72; 455/349

(57) ABSTRACT

A modular entertainment system includes a plurality of electronic components for receiving control signals and providing a controlled output. A plurality of modules are also included. Each module of the plurality of modules is in direct communication with at least one electronic component of the plurality of electronic components. Each module comprises at least one electric power signal and control signal transceiver element to wirelessly share an electric power signal and a control signal with an adjacent module. Each module is disposed in a direction horizontal to the adjacent module.

### RELATED APPLICATION DATA

This application claims priority to provisional application Ser. No. 60/781,604, filed Mar. 10, 2006, the disclosure of which is hereby incorporated by reference.

### FIELD OF THE APPLICATION

The present invention relates generally to a wireless home entertainment system comprised of electronic components affixed to modular panels.

### BACKGROUND

Home entertainment systems traditionally have contained analog technologies that were physically large and heavy. Home entertainment systems are becoming computer/Internet based, making analog technologies less prominent and less necessary than they have ever been in the history of consumer electronics products. There is no longer a need for large boxes to be hooked up to other large boxes with many moving parts all connected by cables and wires. Essentially, a laptop computer is as large as any component (or all components) need to be.

However, a laptop computer has inherent deficiencies as a true home entertainment machine. For example, it cannot produce a wide range of sound output and lacks convenience features such as multiple disk playback, ample amplification, and dedicated controls. It also does not appear to be a home entertainment solution in the classical sense because the average consumer still identifies with a home entertainment system having separate components performing different and obvious functions.

Some video camera systems in the art include a docking station where a user can physically mount a video camera into the docking station. However, such systems are typically used only with video cameras and require the video camera to be placed vertically on top of the docking station. Such arrangements are not visually appealing to the user. Such systems require moving parts on the docking station to lock the video camera into place. Unfortunately, such moving parts can degrade over time and may eventually break, requiring the user to purchase replacement parts.

There are no home entertainment systems in the art that are relatively simple to set up, contain separate components visually pleasing to the average consumer, and are easy and simple to quickly arrange and re-arrange.

### SUMMARY

The present invention is directed to a modular entertainment system that includes a plurality of electronic components for receiving control signals and providing a controlled output. A plurality of modules are also included. Each module of the plurality of modules is in direct communication with at least one electronic component of the plurality of electronic components. Each module comprises at least one electric power signal and control signal transceiver element to wirelessly share an electric power signal and a control signal with an adjacent module. Each module is disposed in a direction horizontal to the adjacent module.

The present invention is also directed to an entertainment system module. A panel is included that forms a base of the entertainment system module. At least one contact element contacts at least one adjacent contact element on an adjacent system module to wirelessly share an electric power signal and a control signal with the adjacent system module. The at least one contact element is disposed within at least one edge of the panel. The entertainment system module is disposed in a direction horizontal to the adjacent system module. At least one electronic component receives the control signal and provides a controlled output in response to the control signal. The at least one electronic component is mounted onto the panel. Circuitry provides the control signal and the electric power signal from the at least one contact element to the at least one electronic component.

The present invention is further directed to a method. An electric power signal is generated. A control signal is also generated. The electric power signal and the control signal are wirelessly shared between at least a first contact element on a first system module and at least a second contact element on a second system module. The first system module comprises at least a first electronic component affixed to a first panel. The second system module comprises at least a second electronic component affixed to a second panel. A controlled output by at least one of the at least a first electronic component and the at least a second electronic component is provided in response to the control signal.

The above summary of the present invention is not intended to represent each embodiment or every aspect of the present invention. The detailed description and Figures will describe many of the embodiments and aspects of the present invention.

### BRIEF DESCRIPTION OF THE DRAWINGS

The above and other aspects, features and advantages of the present embodiments will be more apparent from the following more particular description thereof, presented in conjunction with the following drawings wherein:

FIG. 1 illustrates an entertainment system according to at least one embodiment of the invention;

FIG. 2 illustrates a side perspective view of the first panel and left loudspeaker separated from the rest of the home entertainment system according to at least one embodiment of the invention;

FIG. 3 illustrates components within a panel, which may be similar to the first panel discussed above, according to at least one embodiment of the invention;

FIG. 4 illustrates a method of operation of the home entertainment system according to at least one embodiment of the invention; and

FIG. 5 illustrates a method of operation of the home entertainment system according to at least one embodiment of the invention.

Corresponding reference characters indicate corresponding components throughout the several views of the drawings. Skilled artisans will appreciate that elements in the figures are illustrated for simplicity and clarity and have not necessarily been drawn to scale. For example, the dimensions of some of the elements in the figures may be exaggerated relative to other elements to help to improve understanding of various embodiments of the present invention. Also, common but well-understood elements that are useful or necessary in a commercially feasible embodiment are often not depicted in order to facilitate a less obstructed view of these various embodiments of the present invention.

### DETAILED DESCRIPTION

Embodiments of the present invention are directed to a modular entertainment system having a single controller for controlling all electronic components of the entertainment system. The system includes several electronic components that may include, for example, loudspeakers, a controller, a multi-disc changer, a subwoofer, and a video screen. These components are each attached to a panel. The panel may comprise a flat panel or tile that may be placed on a flat surface, such as a table. Each panel may include one or more of the electronic components. For example, one of the panels may include a loudspeaker, another panel may include a subwoofer, and a third panel may include both the controller and the multi-disc changer. The panels may be disposed horizontally with respect to each other. The panels may each include a means for receiving and/or providing power and an electronic control signal. For example, the panels may include metal or some other type of conductive contacts such that when two panels are placed side-by-side, electric power flows from one of the panels to the other through the contacts. The panels may also transmit electronic control signals via the contacts. In some embodiments the same contacts used to transmit electric power may be used to transmit an electronic control signal. In other embodiments, one set of conductive contacts are used for the transfer of electric power, while another set of contacts are used to transfer a control signal between the panels.

In some embodiments, induction is used to transfer power from one panel to another, in which case conductive contacts would not be required. For example, inductive coils may be utilized to transfer the power. Alternatively, capacitive coupling, similar to that in an electric toothbrush, for example, may be utilized to transfer the power between the panels. In embodiments utilizing induction to transfer power, the control signals may be transferred wirelessly from one panel to another. It should be appreciated that some of the panels may transfer power or the control signals via contacts while others may do so wirelessly via induction.

An advantage of the use of such panels is that it is very simple to set up and is visually appealing. Cables and interlocking elements between the panels are not required. The panels may be quickly rearranged in the event that the user tires of looking at the same arrangement.

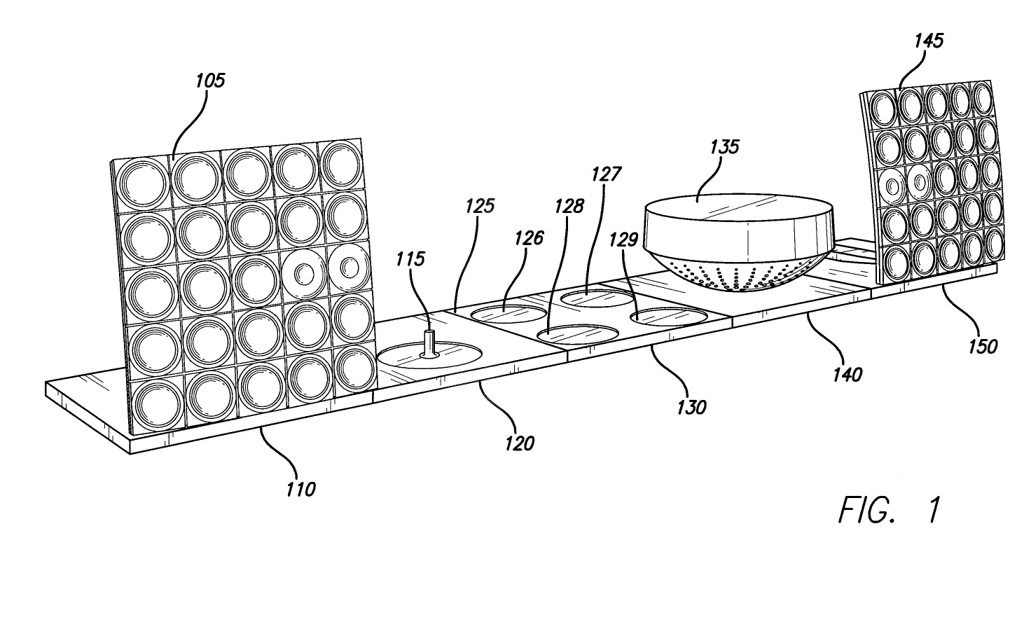

FIG. 1 illustrates an entertainment system 100 according to at least one embodiment of the invention. The entertainment system 100 is comprised of a plurality of electronic components affixed to movable panels. As illustrated, a left loudspeaker 105 is affixed to a first panel 110. The left loudspeaker 105 may be comprised of an array of drivers, such as, for example, 25 drivers. The drivers may include midrange and high frequency drivers driven by amplifiers built into their bases, A controller 115 is affixed to a second panel 120. The controller 115 may be utilized to select media to be played with sound output to, for example, loudspeakers such as the left loudspeaker 105. The controller may present a display to a user and allow the user to select media to be played, as well as, for example, volume levels and acoustic characteristics.

A CD player and changer 125 is affixed to a third panel 130. The CD player and changer 125 may hold 4 discs as shown or may hold more or fewer than 4 discs in different embodiments. The user may select a disc to be played by manipulating a display presented by the controller 115. In the even that a disc, or a song of the disc, is selected, media may be read off the disc and played for the user's enjoyment. In some embodiments, the selected disc is moved over to an optical head that reads the media off the disc. For example, the selected disc may sink down into the CD player and changer 125 and then be transported to the center of the CD player and changer 125 where it is played. In alternative embodiments an optical head may be located beneath each of the disc holding indentations of the CD player and changer 125. As shown, the CD player and changer 125 includes four indentations for holding the discs, a first indentation 126, a second indentation 127, a third indentation 128, and a fourth indentation 129.

It should be appreciated that media other than CD discs, such as CD-ROMs, may be played. For example, in some embodiments the CD player and changer 125 may be replaced with a DVD player and changer so that DVDs can be played back for the user's enjoyment. In alternative embodiments, the CD player and changer 125 may also be capable of playing other types of discs such as blu-ray discs.

A subwoofer 135 is affixed to a fourth panel 140. The subwoofer 135 is utilized to playback low frequency audio. Finally, a right loudspeaker 145 is affixed to a fifth panel 150. The right loudspeaker 145 may be substantially the same as the left loudspeaker 105. The combination of the left loudspeaker and the right loudspeaker may be utilized to provide an audible stereo effect for listeners. The left loudspeaker 105 and the right loudspeaker 145 may be purely stereo speakers in which Digital Signal Processor (“DSP”) control over the drivers is not required.

The entire combination of the first panel 110, second panel 120, third panel 130, fourth panel 140, and fifth panel 150 may be placed on a flat surface such as a table or bookshelf to provide a visually pleasing entertainment center. The first panel 110, second panel 120, third panel 130, fourth panel 140, and fifth panel 150 may each have approximately the same dimensions. For example, each may have a rectangular or square shape such as each side having a length of approximately 15 inches and may be relatively thin with a thickness of about 0.75 inches. It should be appreciated that the dimensions of the panels may differ in other embodiments, depending on the requirements. It should also be appreciated that although five panels are shown in FIG. 1, more or fewer than five panels may alternatively be utilized, depending on the embodiment.

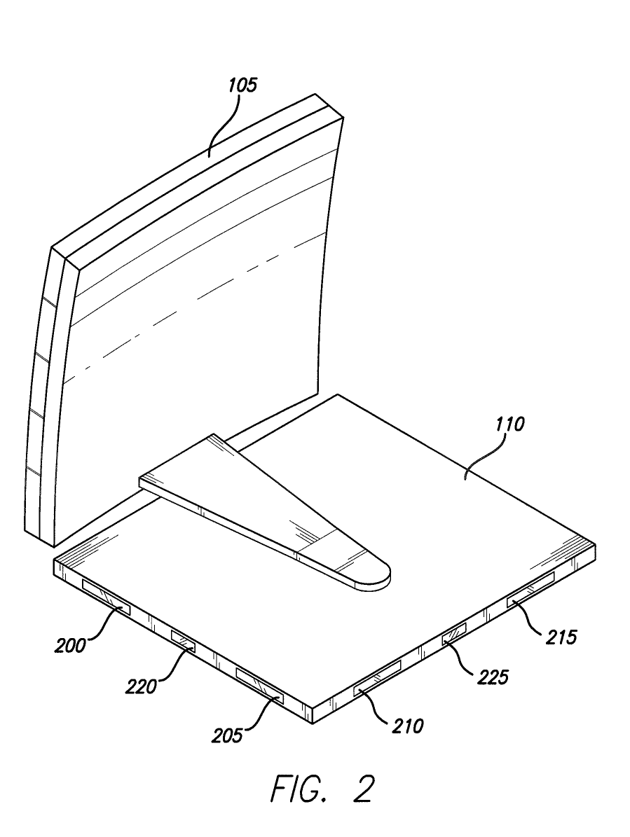

FIG. 2 illustrates a side perspective view of the first panel 110 and left loudspeaker 105 separated from the rest of the home entertainment system 100 according to at least one embodiment of the invention. As shown, the first panel 110 includes contacts, such as a first electrical contact 200, a second electrical contact 205, a third electrical contact 210, and a fourth electrical contact 215. The electrical contacts may be utilized to transfer and receive electric power from the first panel 110 to another panel, such as the second panel 120. The first panel 110 may also include a first control contact 220 and a second control contact 225. The first control contact 220 and the second control contact 225 may be utilized to transfer and receive control signals to/from other adjacent panels. The electrical and control contacts may be located on each side of the first panel 110 such that the first panel 110 can exchange electric power and control signals with other panels located on any side of the first panel 110. It should be appreciated that instead of having two electrical contacts and one control contact on each side, any other suitable number of contacts may be utilized. For example, in some embodiments, a single long contact may be utilized to transfer electrical power and control signals. In other embodiments, for example, four or five small contacts may be utilized on each side of the first panel 110. The electrical and control contacts provide a simple way of exchanging electrical power and control signals. The electrical and control contacts may be formed of electrically conductive materials.

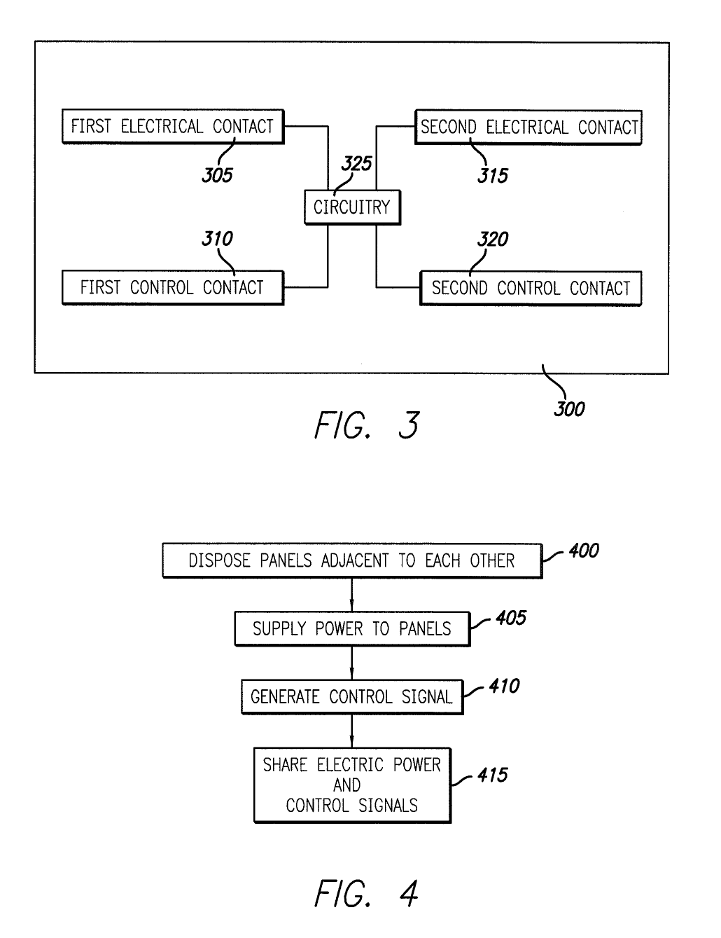

Unlike prior systems that typically require use of cables to connect various electronic components of an entertainment system, the embodiments disclosed herein may be quickly arranged to form the home entertainment system 100. For example, a user may place two panels touching each other side-by-side, such as the first panel 110 and the second panel 120, and the system will operate. The electronic components coupled to each of the panels may receive the electrical power and control signals via circuitry within each of the panels, as discussed below with respect to FIG. 3. Because cables are not required, each panel may be moved as the user seeing fit and placed by a different panel or moved so that a different side of the panel touches an adjacent panel. Because the panels have contacts on multiple sides, a large number of panels may be utilized, so that the user can effectively build a large home entertainment center.

It should also be appreciated that the contacts on each panel may include a spring or some other element to ensure that they stick out beyond the edge of the panel to which they are affixed. When moved next to an adjacent panel, the contacts from the panel may physically touch contacts form the adjacent panel, and the contacts may be retracted slightly from their outward positions. This ensures that the contacts are touching each other so that that the electrical signal and control signal may be exchanged between the panels. In some embodiments, however, spring-like elements are not required and the contacts do not stick out beyond the edges of the panels.

FIG. 3 illustrates components within a panel 300, which may be similar to the first panel 110 discussed above, according to at least one embodiment of the invention. As shown, the panel 300 includes a first electrical contact 305, a first control contact 310, a second electrical contact 315, a second control contact, and a circuitry 325. The first electrical contact 305 and the second electrical contact 315 may receive the electrical power from adjacent panels and transfer electrical power to the adjacent panels. Similarly, the first control contact 310 and the second control contact 320 may receive control signals from adjacent panels and transfer control signals to the adjacent panels. The circuitry 325 is utilized to receive the power and control signals and interface with electronic components to operate the electronic components. For example, in the event that the left loudspeaker 110 is coupled to the panel 300, such as that shown in FIGS. 1 and 2, the left loudspeaker 110 may be in communication with the circuitry to receive the power and control signals.

In some embodiments, the power source of the panel 300 may be located within the panel 300. For example, an electric power signal may be generated by a rechargeable battery system within the panel 300. Alternatively, the panel 300 may be in communication with an electric outlet supplying the power. In embodiments in which electric power is transferred inductively between the panels, inductive coils, similar to those in a rechargeable toothbrush, may also be disposed within the panel 300.

The circuitry 325 shown in FIG. 3 provides an electrical connection between the first electrical contact 305 and the second electrical contact 315 so that electric power can flow entirely through the panel 300 and into an adjacent panel. Similarly, the circuitry 325 also provides an electrical connection between the first control contact 310 and the second control contact 320 so that a control signal can flow entirely through the panel 300 and into an adjacent panel.

FIG. 4 illustrates a method of operation of the home entertainment system according to at least one embodiment of the invention. First, at operation 400, panels are disposed adjacent to each other. In the event that the panels have contacts on their sides, such as those discussed above, the panels may be placed side-by-side allowing their conductive contacts to physically touch so that electric power and control signals can pass between adjacent panels. In alternative embodiments in which induction is utilized to transfer the electric power between panels, the panels are positioned in close proximity to each other but do not necessarily have to physically touch. Next, power is supplied by the panel having the power supply or being in direct communication with the power supply at operation 405. A user may then manipulate a controller to generate a control signal to control the output of the various electronic components of the home entertainment center at operation 410. Finally, the electric power and control signals are shared among the panels and selected electronic components are utilized as directed by the user at operation 415.

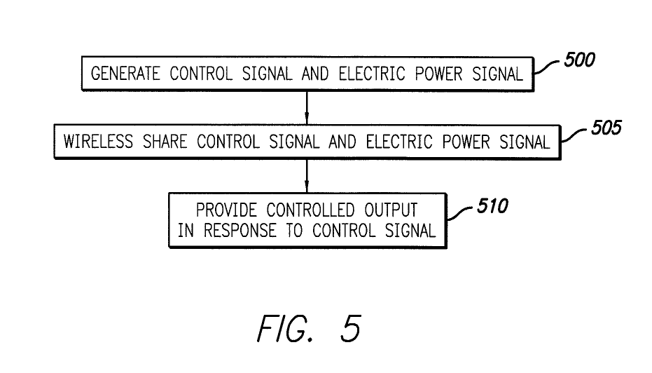

FIG. 5 illustrates a method of operation of the home entertainment system according to at least one embodiment of the invention. First, at operation 500, a control signal and an electric power signal are generated. The control signal is generating by a single controller. Next, at operation 505, the electric power signal and the control signal are wirelessly shared between at least a first contact element on a first system module and at least a second contact element on a second system module. The first system module comprises at least a first electronic component affixed to a first panel. The second system module comprises at least a second electronic component affixed to a second panel. Finally, at operation 510, a controlled output by at least one of the at least a first electronic component and the at least a second electronic component is provided in response to the control signal.

Embodiments of the present invention are directed to a modular entertainment system having a single controller for controlling all electronic components of the entertainment system. The system includes several electronic components that may include, for example, loudspeakers, a controller, a multi-disc changer, a subwoofer, and a video screen. These components are each attached to a panel. The panel may comprise a flat panel or tile that may be placed on a flat surface, such as a table. Each panel may include one or more of the electronic components. For example, one of the panels may include a loudspeaker, another panel may include a subwoofer, and a third panel may include both the controller and the multi-disc changer. The panels may be disposed horizontally with respect to each other. The panels may each include a means for receiving and/or providing power and an electronic control signal. For example, the panels may include metal or some other type of conductive contacts such that when two panels are placed side-by-side, electric power flows from one of the panels to the other through the contacts. The panels may also transmit electronic control signals via the contacts. In some embodiments the same contacts used to transmit electric power may be used to transmit an electronic control signal. In other embodiments, one set of conductive contacts are used for the transfer of electric power, while another set of contacts are used to transfer a control signal between the panels.

In some embodiments, induction is used to transfer power from one panel to another, in which case conductive contacts would not be required. For example, inductive coils may be utilized to transfer the power. Alternatively, capacitive coupling, similar to that in an electric toothbrush, for example, may be utilized to transfer the power between the panels. In embodiments utilizing induction to transfer power, the control signals may be transferred wirelessly from one panel to another. It should be appreciated that some of the panels may transfer power or the control signals via contacts while others may do so wirelessly via induction.

An advantage of the use of such horizontally disposed panels is that it is very simple to set up and is visually appealing. Cables and interlocking elements between the panels are not required. The panels may be quickly rearranged in the event that the user tires of looking at the same arrangement. The panels may be placed side-by-side and the electric power and control signal may therefore travel horizontally from one panel to another panel. This differs from some prior systems that require a component to be vertically mounted onto another component, and is visually pleasing to the user.

Other embodiments, combinations and modifications of this invention will occur readily to those of ordinary skill in the art in view of these teachings. Therefore, this invention is not to be limited to the specific embodiments described or the specific figures provided.

This invention has been described in detail with reference to various embodiments. Not all features are required of all embodiments. It should also be appreciated that the specific embodiments described are merely illustrative of the principles underlying the inventive concept. It is therefore contemplated that various modifications of the disclosed embodiments will, without departing from the spirit and scope of the invention, be apparent to persons of ordinary skill in the art. Numerous modifications and variations could be made thereto by those skilled in the art without departing from the scope of the invention set forth in the claims.

What is claimed is:

1. A modular entertainment system, comprising:
a plurality of electronic components for receiving control signals and providing a controlled output; and
a plurality of modules, each module of the plurality of modules being in direct communication with an electronic component of the plurality of electronic components, wherein each module comprises an electric power signal and control signal transceiver element to share an electric power signal and a control signal with an adjacent module via a cable-less connection, and each module is disposed in a direction horizontal to the adjacent module.

2. The modular entertainment system of claim 1, wherein a module of the plurality of modules supplies the electric power signal to the adjacent module, the electric power signal being generated by at least one of a battery system and communication with an electric outlet.

3. The modular entertainment system of claim 1, wherein the single controller is in communication with an interface for providing user-selectable options, the control signal being based on a selection of the user-selectable options.

4. The modular interface of claim 1, wherein each module comprises at least one conductive contact for sharing the electric power signal and the control signal.

5. The modular interface of claim 4, wherein the at least one conductive contact is stationary.

6. The modular entertainment system of claim 1, wherein the electric power signal is wirelessly transmitted via induction between the plurality of modules.

7. The modular entertainment system of claim 1, wherein each module of the plurality of modules comprises the electric power signal and control signal transceiver element on multiple sides.

8. The modular entertainment system of claim 1, wherein the electric power signal and control signal transceiver element comprises an electric power signal transceiver and a separate control signal transceiver.

9. An entertainment system module, comprising:
a panel, wherein the panel forms a base of the entertainment system module;
at least one contact element to contact at least one adjacent contact element on an adjacent system module to share an electric power signal and a control signal with the adjacent system module via a cable-less connection, wherein the at least one contact element is disposed within at least one edge of the panel, and the panel is disposed in a direction horizontal to the adjacent system module;
at least one electronic component to receive the control signal and provide a controlled output in response to the control signal, wherein the at least one electronic component is mounted onto the panel; and
circuitry to provide the control signal and the electric power signal from the at least one contact element to the at least one electronic component.

10. The entertainment system module of claim 9, wherein the entertainment system module supplies the electric power signal to the adjacent module, the electric power signal being generated by at least one of a battery system and communication with an electric outlet.

11. The entertainment system module of claim 9, further comprising a single controller and an interface for providing user-selectable options, the control signal being based on a selection of the user-selectable options.

12. The entertainment system module of claim 9, wherein the at least one contact is stationary.

13. The entertainment system module of claim 9, wherein the at least one contact comprises a first contact to share only the electric power signal and a second contact to share only the control signal.

14. The entertainment system module of claim 9, wherein the at least one contact element is disposed on multiple sides of the panel.

15. A method, comprising:
generating an electric power signal;
generating a control signal;
sharing the electric power signal and the control signal between at least a first contact element on a first system module and at least a second contact element on a second system module via a cable-less connection, wherein the first system module comprises at least a first electronic component affixed to a first panel, and the second system module comprises at least a second electronic component affixed to a second panel; and
providing a controlled output by at least one of the at least a first electronic component and the at least a second electronic component in response to the control signal.

16. The method of claim 15, further comprising providing user-selectable options to a user via an interface, and wherein generating the control signal comprises generating the control signal based on a selection of the user-selectable options.

17. The method of claim 15, wherein sharing the electric power signal and the control signal comprises sharing the electric power signal and the control signal via at least a first conductive contact disposed within the first panel, and at least a second conductive contact disposed within the second panel.

18. The method of claim 15, wherein sharing the electric power signal and the control signal comprises wirelessly transmitting the electric power signal via induction.
